(19) United States
(12) Patent Application Publication
(10) Pub. No.: US 2024/0188558 A1
(43) Pub. Date: Jun. 13, 2024

(54) Hang On Portable Tree Stand

(71) Applicant: Elevate Stand Co LLC, Hutchinson, KS (US)

(72) Inventor: Matthew Garcia, Hutchinson, KS (US)

(21) Appl. No.: 18/521,369

(22) Filed: Nov. 28, 2023

Related U.S. Application Data
(60) Provisional application No. 63/386,339, filed on Dec. 7, 2022.

(51) Int. Cl. A01M 31/02

(52) U.S. Cl. CPC A01M 31/02

(57) ABSTRACT

A hang on portable tree stand includes a pair of upright posts each having openings extending through a thickness; a seat engaged with the upright posts and having irregularly shaped openings; a base platform pivotally engaged with the upright posts and having irregularly shaped openings; supports extending from the base platform to the upright posts, the supports being flexible such that the base platform can pivot; braces extending from the upright posts; and a strap receiver extending from the upright posts; the base platform and the one or more braces engage with a support structure when the hang on portable tree stand is installed on the support structure; and the strap receiver is to receive a strap to secure around the support structure and hold the hang on portable tree stand in place once installed.

### CROSS-REFERENCE TO RELATED APPLICATION

This application claims the benefit of priority of U.S. Provisional Patent Application No. 63/386,339, filed on Dec. 7, 2022, the disclosure of which is herein incorporated by reference in its entirety.

### BACKGROUND

### 1. Field

Embodiments of the disclosure relate to tree stands, and in particular to hang on portable tree stands.

### 2. Related Art

Tree stands are known in the prior art. For example, U.S. Pat. No. 6,866,120B1 to Butterworth discloses a tree stand with a seating platform and a standing platform that are adjustable in angle relative to a tree. U.S. Pat. No. 3,871,482A to Southard discloses a tree stand with a seat supported by legs and a base that are foldable into a generally flat configuration. U.S. Pat. No. 7,926,775B1 to Milazzo et al. discloses a tree stand with a seat platform and a base platform having an open weave configuration and having concave brackets for affixing to the tree. U.S. Pat. No. 5,060,756A to D'Acquisto discloses a tree stand having a seat and a base that are of an open, grate-like configuration and having a bracket with teeth for engaging with the tree.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In some aspects, the present invention described herein relates to a hang on portable tree stand, comprising one or more upright posts extending from a top end to a bottom end, each of the one or more upright posts having a plurality of openings extending through a thickness of each of the one or more upright posts; a seat engaged with the one or more upright posts, the seat having a plurality of irregularly shaped openings extending through a thickness of the seat; a base platform pivotally engaged with the one or more upright posts, the base platform having a plurality of irregularly shaped openings extending through a thickness of the base platform; one or more supports extending from the base platform to the one or more upright posts, the one or more supports being laterally flexible while at the same time being tensily rigid such that the base platform can pivot toward the one or more upright posts; one or more braces extending from the one or more upright posts; and a strap receiver extending from the one or more upright posts. The base platform and the one or more braces are configured to engage with a support structure when the hang on portable tree stand is installed on the support structure; and the strap receiver is configured to receive a strap, the strap being configured to secure around the support structure and hold the hang on portable tree stand in place once installed.

In other aspects, the present invention described herein further relates to a combination of a hang on portable tree stand and a set of climbing sticks, the combination comprising the hang on portable tree stand having a pair of upright posts extending from a top end to a bottom end; a seat engaged with the pair of upright posts near the top end; a base platform pivotally engaged with the pair of upright posts near the bottom end, the base platform having one or more hooks extending from an edge of the base platform; one or more supports extending from the base platform to the pair of upright posts, the one or more supports being configured to allow the base platform to pivot toward the pair of upright posts; one or more braces extending from the pair of upright posts and configured to engage with a support structure; and a strap receiver extending from the pair of upright posts and configured to receive a strap to secure the hang on portable tree stand to the support structure. The set of climbing sticks including a first climbing stick having a support bar extending from a top end to a bottom end, a top foot rung secured to the support bar near the top end, a bottom foot rung secured to the support bar near the bottom end, and a climbing stick strap receiver extending from the support bar. The first climbing stick is configured to attach to the base platform via the climbing stick strap receiver engaging with one of the one or more hooks such that the one of the one or more hooks retains the first climbing stick to the base platform.

### BRIEF DESCRIPTION OF THE DRAWING FIGURES

Embodiments of the invention are described in detail below with reference to the attached drawing figures, wherein:

FIG. 1 is an angled perspective view of an embodiment of a portable hang on tree stand in accordance with the present invention.

FIG. 2 is a side view of the portable hang on tree stand of FIG. 1.

FIG. 3 is an angled perspective view of the portable hang on tree stand of FIG. 1 secured to a tree.

FIG. 4 is a close up view of an attachment between a strap and a strap receiver of the portable hang on tree stand of FIG. 1.

FIG. 5 is a close up of the strap receiver of the portable hang on tree stand of FIG. 1.

FIG. 6 is a top view of a base platform of the portable hang on tree stand of FIG. 1.

FIG. 7 is an angled perspective view of an alternative embodiment of a portable hang on tree stand in accordance with the present invention.

FIG. 8 is a side view of the portable hang on tree stand of FIG. 7.

FIG. 9 is a top view of a base platform of the portable hang on tree stand of FIG. 7.

FIG. 10 is an angled perspective view of another embodiment of a portable hang on tree stand in accordance with the present invention.

FIG. 11 is a side view of the portable hang on tree stand of FIG. 10.

FIG. 12 is a top view of a base platform of the portable hang on tree stand of FIG. 10.

FIG. 13 is a side view of a climbing stick for attaching to the portable hang on tree stand of FIG. 7 or the portable hand on tree stand of FIG. 10.

FIG. 14 is a back view of the portable hang on tree stand of FIG. 7 with the base platform folded for transport and two sets of climbing sticks attached thereto.

FIG. 15 is a back view of the portable hang on tree stand of FIG. 10 with the base platform folded for transport and two sets of climbing sticks attached thereto.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Tree stands, including portable, hang on tree stands, are commonly used by outdoorsmen for gaining an advantage viewpoint of wildlife, such as during hunting. Portable, hang on tree stands are conventionally transported with and by the user, and may include one or more platforms for standing and/or sitting. In addition, portable, hang on tree stands are conventionally secured to a tree by one or more straps.

The portable hang on tree stand of the present invention (herein referred to as “tree stand”) comprises one or more upright posts extending from a top end to a bottom end with a seat near the top end and a base platform near the bottom end, wherein a user will utilize one or more straps to secure the stand to a tree at a desired position above a ground surface. In embodiments, the one or more upright posts is a pair of posts extending from the top end to the bottom end such that the seat and the base both engage with both of the upright posts. It should be appreciated that the configuration and use of a pair of upright posts provides for improved stability, wherein weight or pressure applied unevenly to areas of the base platform and/or seat cause limited shifting of the vertical system, and therefore increases the overall stability and comfort of the tree stand. The seat and base platform are generally moveable via pivoting connections, the base platform being generally collapsible, thereby allowing for a user to compact the tree stand for easy transport. The user will transport the tree stand to a desired location, and accordingly, it is important that the tree stand is compact and light enough in weight to allow for easy transportation. In at least some embodiments, a plurality of irregularly shaped openings through the seat and base platform, along with a selection of light-weight materials used to construct the majority of components, e.g., lightweight metals or other materials, e.g., aluminum in embodiments, allow for the tree stand to be easily carried and/or lifted by a user.

Once at the desired location, the user will deploy and adjust the seat and base platform into substantially horizontal configurations, secure the upright posts to the tree via one or more straps, and engage one or more braces, each having a plurality of teeth, against the tree, thereby creating a secure, friction engagement with the tree. In some embodiments, the seat and base platform are adjustable in angle to provide the user with adjustability for use in difficult trees. In some embodiments, the tree stand includes one or more attachment devices for receiving one or more accessories, thereby providing for consolidation of equipment for the user.

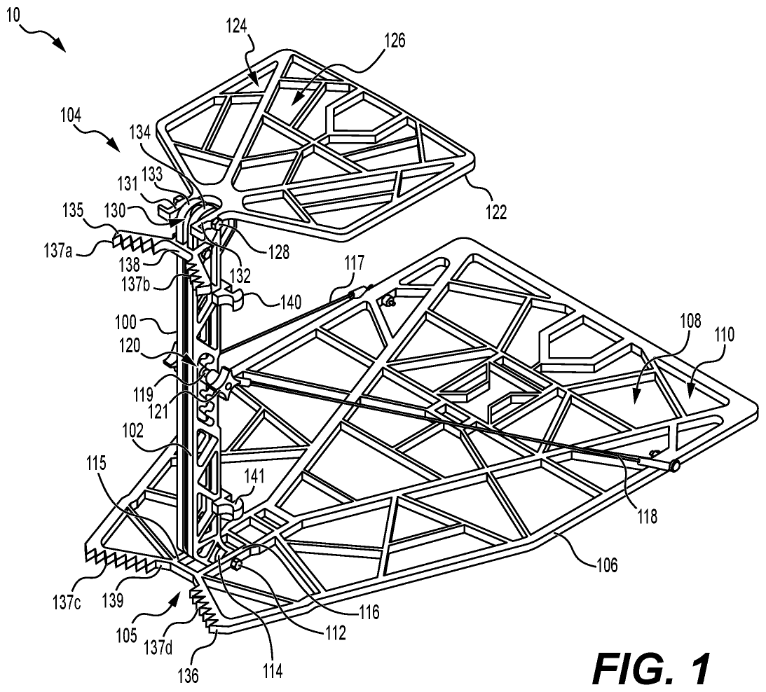

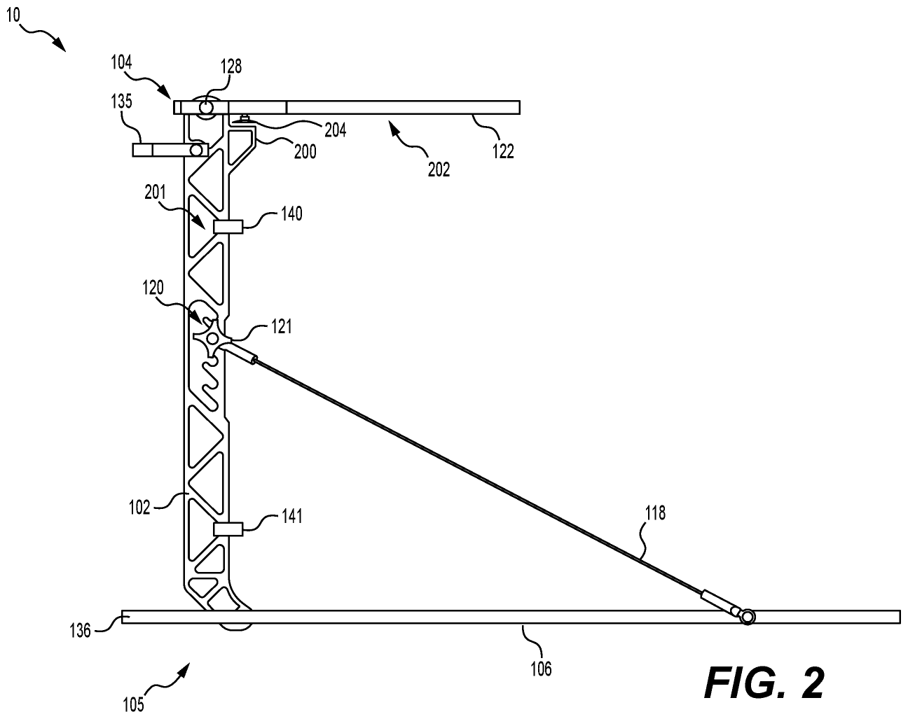

FIGS. 1 and 2 show a first embodiment of a hang on portable tree stand 10. Tree stand 10 includes upright posts 100, 102 extending from a top end 104 to a bottom end 105. As shown, in at least some embodiments, the upright posts 100, 102 is a pair of posts and each includes a plurality of openings 201 to reduce the weight of the tree stand 10. The tree stand 10 further includes a base platform 106 pivotally engaged with the upright posts 100, 102 near the bottom end 105, the base platform 106 also including a plurality of irregularly shaped openings 108, 110 extending through a thickness of the base platform 106, again reducing an overall weight of the tree stand.

The pivotal attachment between the base platform 106 and the upright posts 100, 102 may be achieved via a means known in the art, such as a pin 112 received through a transverse bore 114, or other means. In embodiments, the bore 114 extends through posts 100, 102 and bars 115, 116 of the base platform 106, thereby connecting the components together via pin 112 extending through the bars 115, 116 and the posts 100, 102. In embodiments, the bars 115, 116 are positioned outside of the posts 100, 102 as shown. This configuration creates multiple points of connection between the base platform 106 and the posts 100, 102, namely the base platform 106 is connected to multiple vertical posts 100, 102, thereby increasing stability of the base platform 106 when in use. For example, should a user lean or stand near a corner or edge of the base platform 106, the connection of the base platform 106 to a pair of posts 100, 102 (as opposed to a single post) provides more resistance to pivoting or shifting of the vertical system 100.

The base platform 106 is further secured to the upright posts 100, 102 via one or more supports 117, 118 extending from the upright posts 100, 102 to the base platform 106. In at least some embodiments, the one or more supports 117, 118 are a first cable and a second cable, the cables extending from the base platform 106 to a bar 119. The bar 119 engages with the upright posts 100, 102 via a groove 120 of a plurality of grooves along extending through the upright posts 100, 102, the plurality of grooves aligned vertically to allow for multiple vertical positions for the bar 119. Each groove 120 in the plurality has a different vertical position, enabling the bar 119 to be secured at each of the different positions as desired or needed by the user. In use, the user will pivot the base platform 106 upward to relax tension on the supports 117, 118 thereby releasing force applied to the bar 119 and allowing the bar 119 to be adjusted vertically. One or more handles 121 may extend from the bar 119 to allow for easy user manipulation of the bar 119. Location of the bar 119 in any one of the plurality of grooves allows for the bar 119 to be vertically positioned, allowing for the adjusting of an angle of the base platform 106 relative to the one or more upright posts 100, 102. This allows for a user to adjust the angular position of the base platform 106 if needed, such as when the installation is made into a difficult tree having considerable obstructions (e.g., branches).

Tree stand 10 further includes a seat 122 pivotally engaged with the posts 100, 102 near the top end 104. The seat 122 also has a plurality of irregularly shaped openings 124, 126 extending through a thickness of the seat 122 to aid in weight reduction. The pivotal attachment between the seat 122 and the posts 100, 102 may be achieved via a means known in the art, such as a pin 128 received through a transverse bore 130 made through opposing rearwardly extending portions 131, 132 of the seat 122 which are located outside of upper ends 133, 134 of each of the upright posts 100, 102. The bore 130 extending through portions 131, 132 and upper ends 133, 134, such that insertion of the pin 128 therethrough connects the seat 122 to the posts 100, 102. This configuration creates multiple points of connection between the seat 122 and the posts 100, 102, namely the seat 122 is connected to multiple vertical posts 100, 102, thereby increasing stability of the seat 122 when in use. For example, should a user lean or otherwise apply pressure near a corner or edge of the seat 122, the connection of the seat 122 to a pair of posts 100, 102 (as opposed to a single post) provides more resistance to pivoting or shifting of the vertical system 100.

As best shown in a side view in FIG. 2, tree stand 10 may further include a shelf 200 extending in a forward direction from at least one of the posts 100, 102 at a position below a bottom surface 202 of the seat 122. The shelf 200 may vary in size and shape and provides for a surface to engage with a button 204 extending downward from the bottom surface 202 of the seat 122 at a position above the shelf 200. The button 204 rests on the shelf 200 and tightens and loosens, such as through a threaded connection, from the seat 122. As the button 204 is loosened, the distance between the button 204 and bottom surface 202 increases, thereby increasing an angle between the seat 122 and the one or more upright posts 100, 102. This allows for a user to alter an angle between the seat 122 and the one or more upright posts 100, 102 such as for use with trees presenting interfering branches or other obstructions the angling of the base and platform are able to avoid/work around.

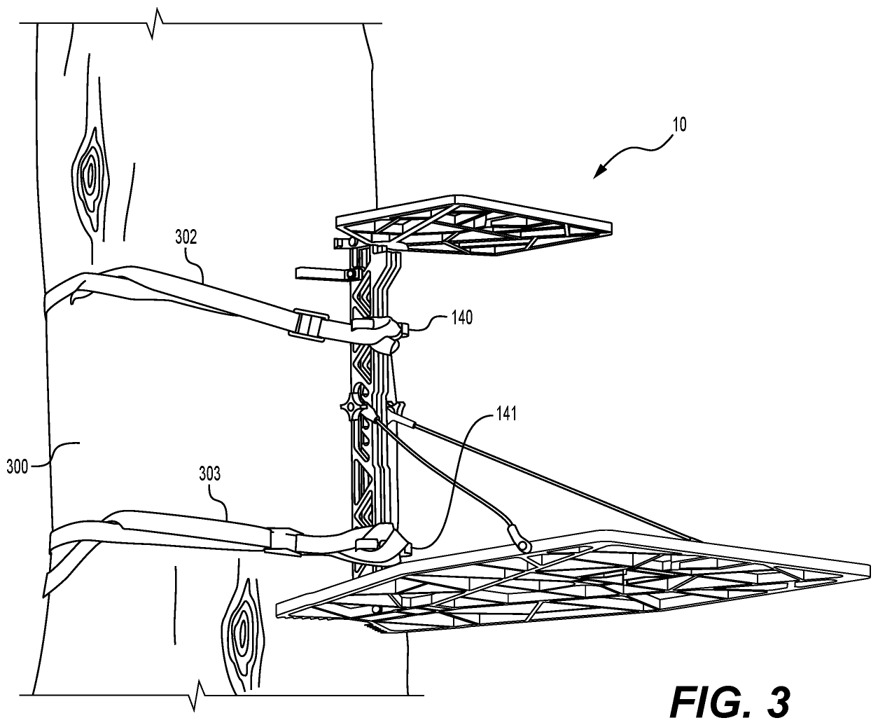

Tree stand 10 further includes one or more tree-engaging braces, e.g., an upper brace 135 and a lower brace 136. The upper brace 135 is fixed to the upright posts 100, 102 at a position slightly below the connection between the seat 122 and the posts 100, 102. Lower brace 136 is integrated with and located at the back end of the base platform 106 to engage a tree behind the upright posts 100, 102. Both tree-engaging braces 135, 136 having two sets of teeth 137a, 137b, 137c, 137d extending therefrom, the braces 135, 136 extending in a direction opposite from the base platform 106 and the seat 122. The braces 135, 136 each comprise outwardly angled, substantially-straight jaws which support the sets of teeth 137a-d (and extend out from a slightly concave untoothed intermediate connecting portions 138, 139. The angles of each of the jaws are selected to conform to an average tree diameter (more specifically, to be substantially tangential relative to an average tree diameter) such that the sets of teeth 137a-d are configured to engage with the tree to support the tree stand 10 at the position above the ground surface. This is demonstrated in FIG. 3.

Again, lower brace 136 is integral with the base platform 106. This allows for the brace 136 to pivot with the base platform 106. During use, the user can pivot the base platform 106 upwards, secure the tree stand 10 to a tree, and then push the base platform 106 downwards, wherein the brace 136 will simultaneously pivot upwards and due to the leverage created, e.g., by the weight of a user, the teeth on each side of the brace 136 dig into the mass of the tree creating a strong, friction hold securement.

Tree stand 10 further includes a first strap receiver 140 extending from at least one of the posts 100, 102, the strap receiver 140 receives a first end of a strap and a second end of a strap to secure the tree stand 10 along a tree, thereby securing the tree stand 10 at the position above the ground surface along the tree, again demonstrated best in FIG. 3. It will be appreciated and understood that the first strap receiver 140 can vary in configuration, such as including hooks or knobs to receive the strap. In some embodiments, the tree stand 10 may include a second strap receiver 141 thereby allowing for two locations of securement to the tree. A user can elect to use one or two straps as desired.

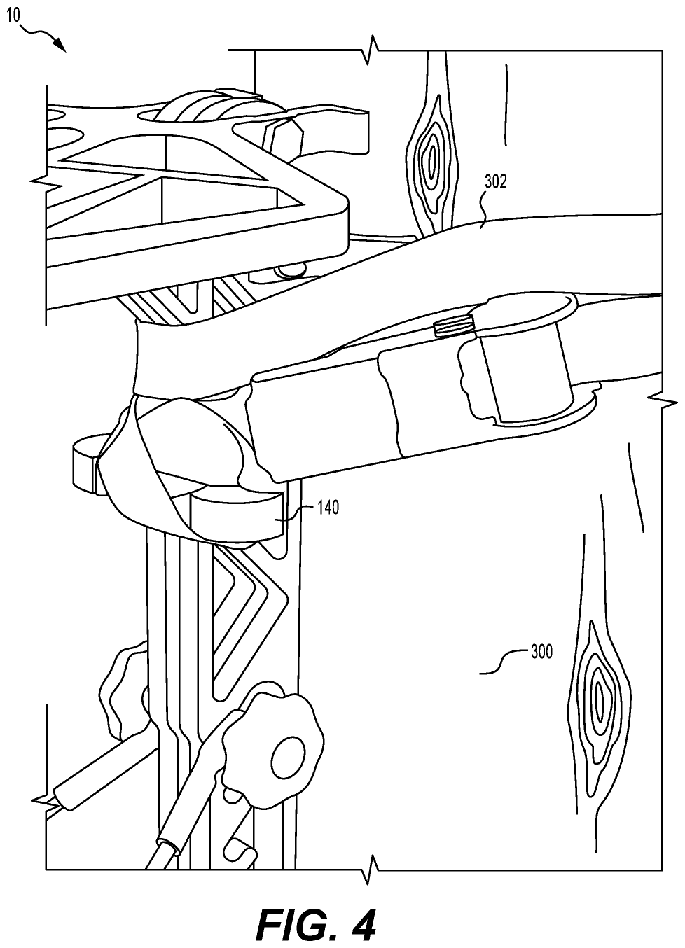

In FIG. 3, an angled view demonstrates tree stand 10 secured to a tree 300 via two straps 302, 303. Again, it should be appreciated that the user may utilize a single or multiple straps. The straps 302, 303 may vary, such as being a cam strap or a ratchet strap. In FIG. 4, a close-up, angled view depicts strap 302 secured to strap receiver 140 and extending around tree 300.

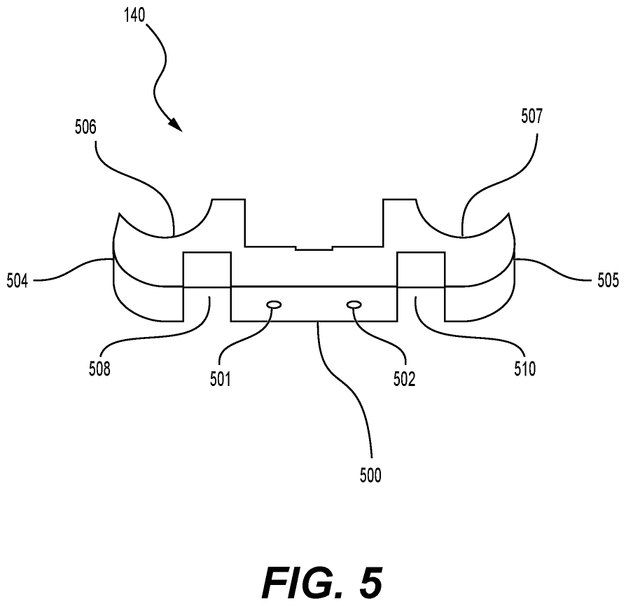

In FIG. 5, a front view depicts an embodiment of a strap receiver 140. As will be understood, strap receivers 140 and 141 can be identical. Strap receiver 140, in embodiments, includes a center bridge 500 with one or more connectors 501, 502 to secure the center bridge 500 to posts 100, 102. On opposing ends of the center bridge 500 are receiving elements 504, 505 to which the strap may be wrapped and secured around. The receiving elements 504, 505, in embodiments, include semicircular indentions 506, 507 facing to the rear, and rectangular indentions 508, 510 facing forward. The indentions allow for the strap to secure to the strap receiver 140, as best shown in FIG. 4. As those skilled in the art would readily understand, the strap receiver 140 can vary in configurations.

The primary components of the tree stand 10, namely the posts 100, 102, seat 122, base platform 106, braces 135, 136, shelf 200, and strap receivers 140, 141, may be composed of 6061-T6 aluminum. Other materials may be selected. The weight of tree stand 10 may vary, however in at least some embodiments, tree stand 10 weighs approximately 10.4 lbs.

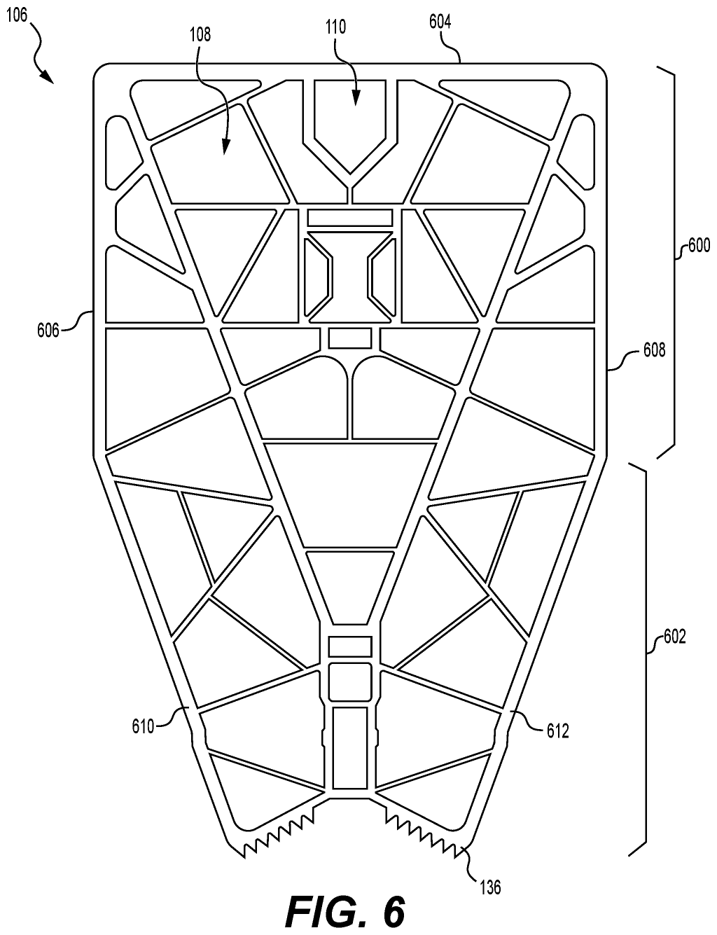

In FIG. 6, a top down view of the base platform 106 is shown for clarity. Base platform 106 again includes the plurality of irregularly shaped openings 108, 110. In this embodiment, the base platform 106 includes a front section 600 integral with a back section 602. The front section 600 is substantially rectangular in shape, being defined by a front end edge 604 with two side edges 606, 608 extending therefrom at substantially right angles (90 degrees). The back section 602 angles inward to the brace 136. In other words, two back section side edges 610, 612, which are integral with the side edges 606, 608, angle inward and connect the front section 600 to the back brace 136. Although the shapes of the openings may vary in embodiments, it is contemplated that at least the configuration shown in FIG. 6, provides for structural integrity and stability in use.

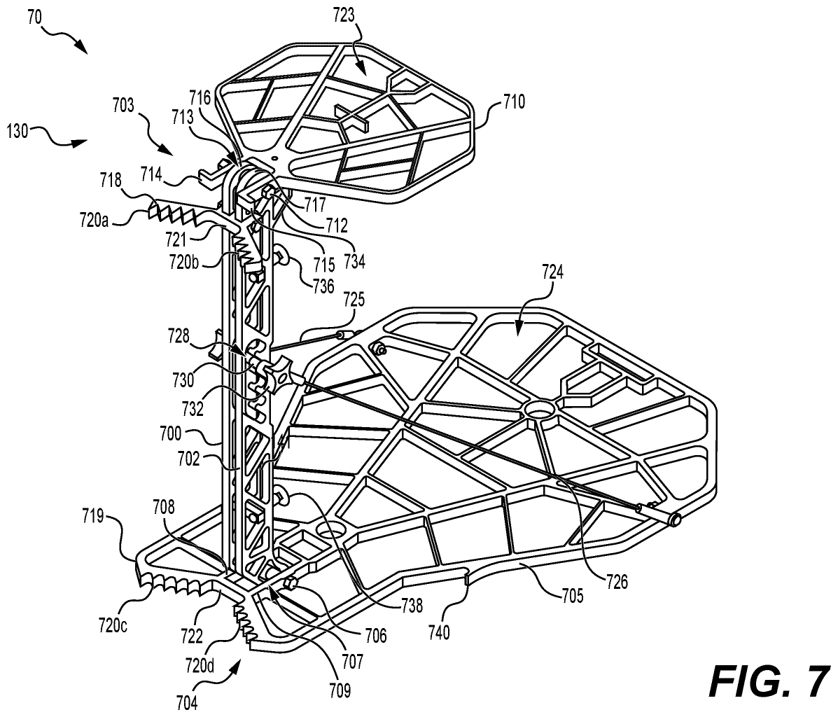

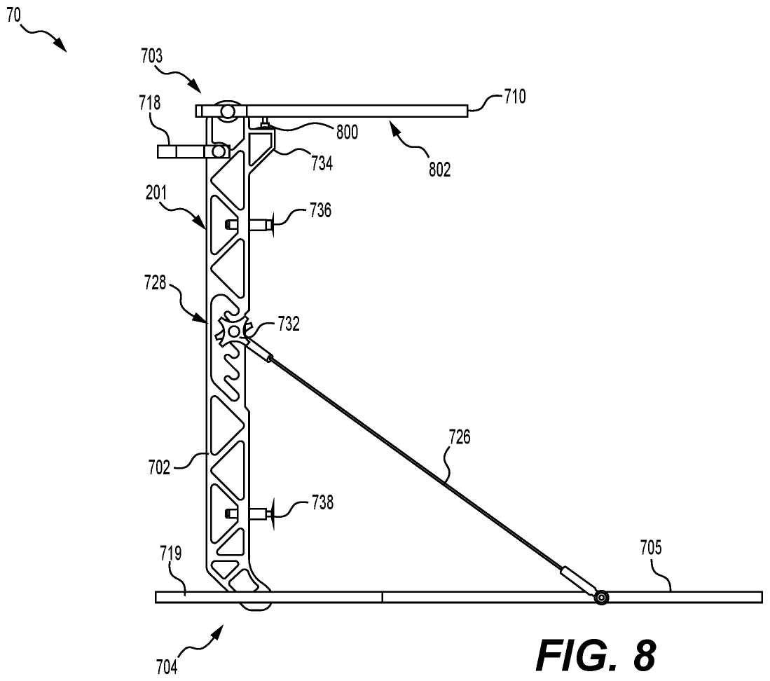

In FIGS. 7 through 9, an alternative embodiment of a tree stand 70 in accordance with the present invention is shown. Tree stand 70 includes many of the same features as tree stand 10 and provides for the same benefits, namely a lightweight, portable, and structurally stable tree stand.

Tree stand 70 includes one or more upright posts 700, 702 extending from a top end 703 to a bottom end 704. As discussed above, the use of a pair of upright posts 700, 702 improves stability of the tree stand 70 during use. A base platform 705 is pivotally engaged with the posts 700, 702 via any means known in the art, such as a pin 706 received through a transverse bore 707, or other means. In embodiments, the bore 707 extends through upright posts 700, 702 and one or more bars 708, 709 of the base platform 705 positioned outside of upright posts 700, 702, thereby connecting the components together via pin 706.

A seat 710 is pivotally engaged with the posts 700, 702. The pivotal attachment between the seat 710 and the posts 700, 702 may be achieved via a means known in the art, such as a pin 712 received through a transverse bore 713 made through opposing rearwardly extending portions 714, 715 of the seat 710 which are located outside of upper ends 716, 717 of each of the upright posts 700, 702. The bore 713 extending through portions 714, 715 and upper ends 716, 717, such that insertion of the pin 712 therethrough connects the seat 710 to the posts 700, 702.

Tree stand 70 further includes one or more tree-engaging braces, e.g., an upper brace 718 and a lower brace 719. The upper brace 718 is fixed to the upright posts 700, 702 at a position slightly below the connection between the seat 710 and the upright posts 700, 702. Lower brace 719 is integrated with and located at the back end of the base platform 705 to engage a tree existing behind the posts 700, 702. Both tree-engaging braces 718, 719 having two sets of teeth 720a, 720b, 720c, 720d extending therefrom, the one or more braces 718, 719 extending in a direction opposite from the base platform 705 and the seat 710. The one or more braces 718, 719, each comprise outwardly angled, substantially-straight jaws which support the sets of teeth 720a-d (and extend out from a slightly concave untoothed intermediate connecting portions 721, 722. The angles of each of the jaws are selected to conform to an average tree diameter (more specifically, to be substantially tangential relative to an average tree diameter) such that the sets of teeth 720a-d are configured to engage with the tree to support the tree stand 70 at the position above the ground surface.

Again, lower brace 719 is integral with the base platform 705. This allows for the brace 719 to pivot with the base platform 705. During use, the user can pivot the base platform 705 upwards, secure the posts 700, 702 to a tree, and then push the base platform 705 downwards, wherein the brace 719 will simultaneously pivot upwards and due to the leverage created, e.g., by the weight of a user, the teeth on each side of the brace 719 dig into the mass of the tree creating a strong securement.

Further, the seat 710 and base platform 705 both include irregularly shaped openings 723, 724 to reduce overall weight of the tree stand 70. Tree stand 70 includes one or more supports 725, 726 for supporting to the base platform 705. The supports 725, 726 in embodiments, are cables, however those skilled in the art will understand alternatives. The base platform 705 is adjustable via a plurality of grooves 728 of varying vertical positions, configured to receive a bar 730 with one or more handles 732. Again, the user can pivot the base platform 705 upwards, releasing tension on supports 725, 726 such that the bar 730 can easily move between the plurality of grooves 728 to adjust a vertical position of the bar 730.

In embodiments, a shelf 734 and button 800 are used for seat 710 adjustability. The button 800 may rotate to adjust a distance between the button 800 and bottom surface 802 of the seat 710, such that an angle between the bottom surface 802 and posts 700, 702 is adjusted as the button 800 rests on the shelf 734.

The overall weight of tree stand 70 in at least some embodiments is approximately 6.25 lbs, again with the primary components being composed of 6061-T6 aluminum.

Tree stand 70 provides for a plurality of alternative features, including one or more strap receivers 736, 738 that extend forward and are in the shape of knobs for receiving straps to secure to a tree. The straps will secure to the receivers 736, 738, such as via hoops, and then wrap around the tree for securement. The user may still decide to use one or more straps per their preference.

Tree stand 70 further includes one or more hooks 740, 742 that extend from, and may be integral with, the base platform 705, the hooks 740, 742 providing locations to secure accessories by the user. For example, the user may secure climbing sticks or other accessories to the hooks 740, 742 thereby compacting their gear for easy transport.

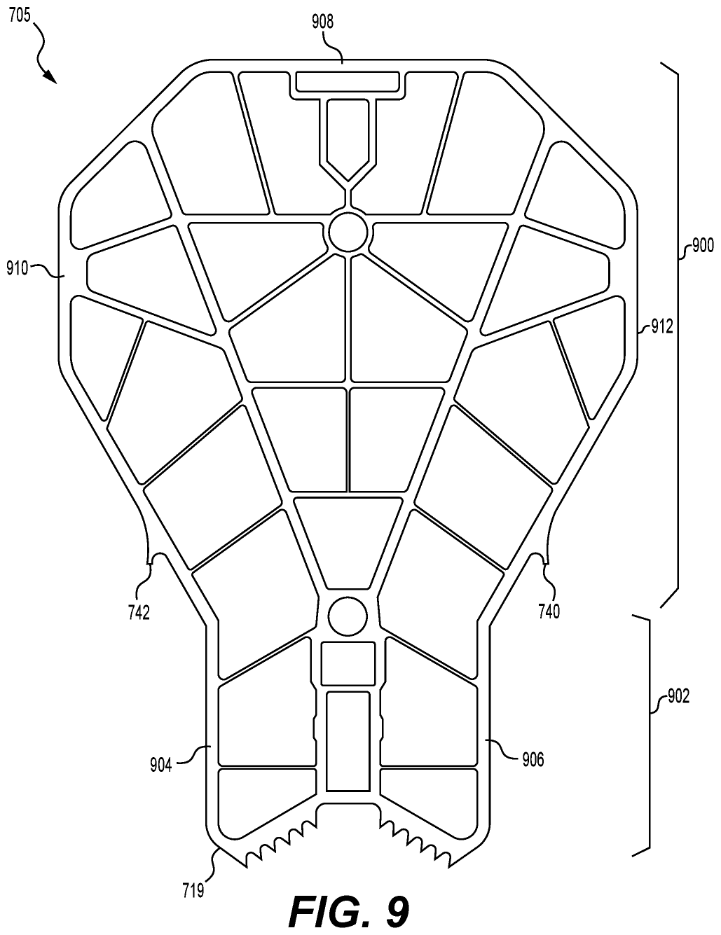

FIG. 9 depicts a top down view of the base platform 705. The base platform 705 includes a front section 900 integral with a back section 902. Here, the back section 902 is defined by the back brace 719 with a first back section side edge 904 and a second back section side edge 906 extending away from the brace 719 and running parallel to one another. The front section 900 is defined by a front end edge 908 integral with a first side edge 910 and a second side edge 912, each traveling to the respective back section side edges 904, 906 as shown. Instead of running parallel (as with the base platform 106 previously discussed), the side edges 910, 912 are each angled away from the front edge 908 at a first section, and then the side edges 910, 912 bend such that they are running parallel to one another until reaching a second bend, at which point the side edge 910, 912 angle inward to meet the back section side edges 904, 906. Accordingly, the base platform 705 includes a wide forward area for the user to stand on and maneuver on during use.

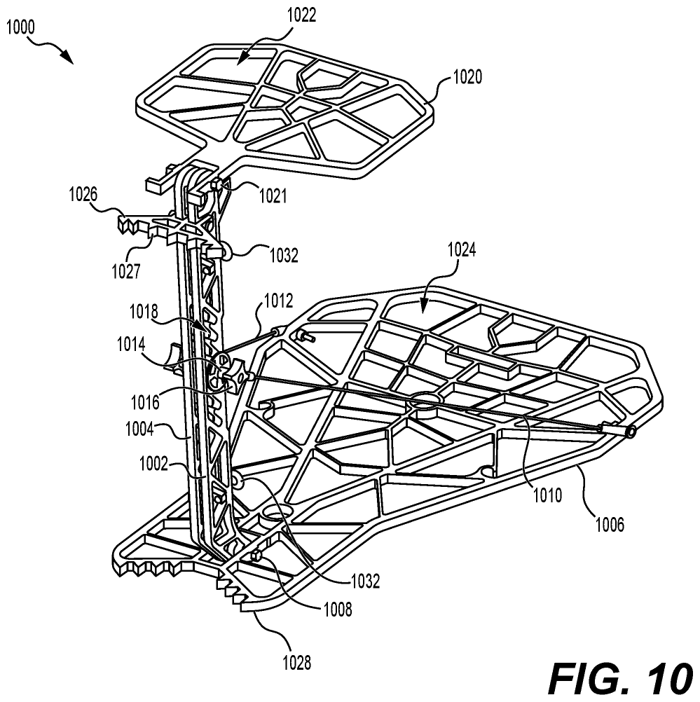

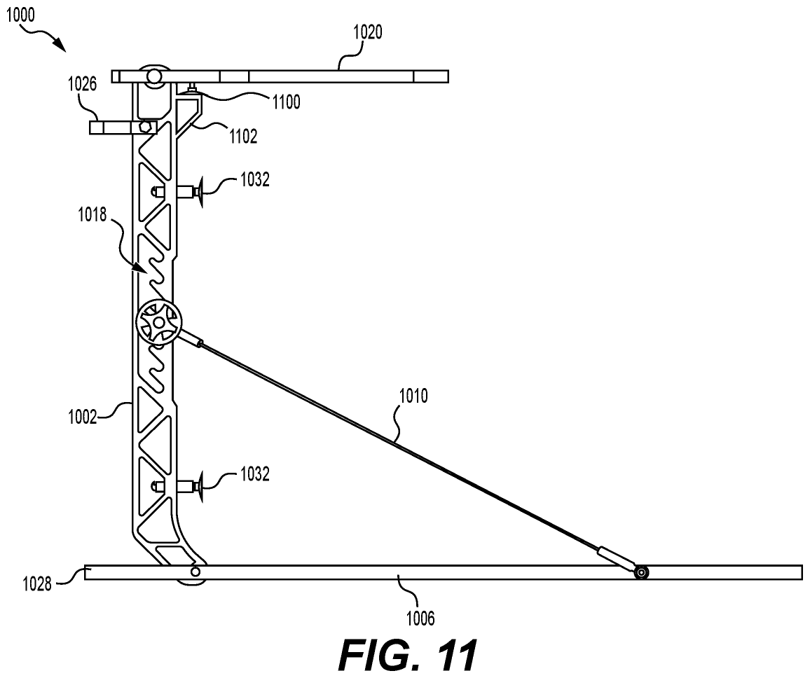

In FIGS. 10-12, another embodiment of a hang on portable tree stand 1000 is shown. Those skilled in the art will appreciate that the features of the various embodiments, namely tree stand 10, tree stand 70, and tree stand 1000, can be interchanged. Tree stand 1000 includes upright posts 1002, 1004 extending from a top end to a bottom end. A base platform 1006 is pivotally secured to the upright posts 1002, 1004, such as via a pin 1008 as discussed above. Supports 1010, 1012 extend from the base platform 1006 to a bar 1014 with one or more handles 1016, the bar 1014 adjustably secured within one of a plurality of grooves 1018 as previously discussed. The supports 1010, 1012 are laterally flexible while at the same time being substantially tensily rigid. That the supports having tensile rigidity allows for the base platform 1006 to pivot upward to collapse against the upright posts 1002, 1004 while still fully supporting a user when the platform is deployed.

A seat 1020 is pivotally engaged with the posts 1002, 1004 such as via a pin 1021 and supported at a desired angle via an adjustable button 1100 and shelf 1102. The seat 1020 and the base platform each have a plurality of irregularly shaped openings 1022, 1024 for weight reduction.

An upper brace 1026 and a lower brace 1028 allow for the tree stand 1000 to engage with a support structure, such as a tree, wherein a plurality of teeth dig into a mass of the tree to create a frictional grip against the tree and aid in retaining the tree stand 1000 at the desired vertical position above the ground surface. In this embodiment, the top brace 1026 includes center teeth 1027 for additional grip into a tree. In addition, one or more strap receivers 1030, 1032 extend forward from the upright posts 1002, 1004 and provide locations for straps to secure around the tree and to the tree stand 1000. The majority of the components making up tree stand 1000 are composed of light weight materials, such as aluminum, and in embodiments tree stand 1000 has a weight of approximately 8 pounds.

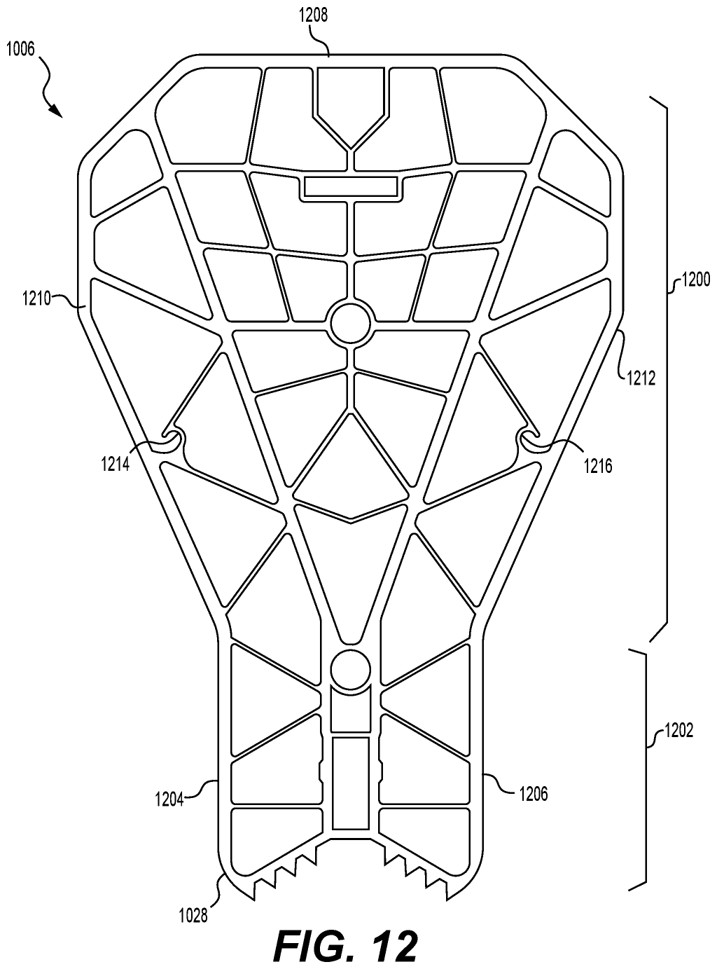

In FIG. 12, a top down view further depicts the base platform 1006, which is similar to base platform 705 in shape. Specifically, a front section 1200 is integral with a back section 1202. The back section 1202 is defined by the brace 1028 with a first back section side edge 1204 and a second back section side edge 1206 extending away from the brace 1028 and running parallel to one another. The front section 1200 is defined by a front end edge 1208 integral with a first side edge 1210 and a second side edge 1212, each traveling to the respective back section side edges 1204, 1206 as shown. Instead of running parallel (as with the base platform 106 previously discussed), the side edges 1210, 1212 are each angled away from the front edge 1208 at a first section, and then the side edges 1210, 1212 bend such that they are running parallel to one another until reaching a second bend, at which point the side edge 1210, 1212 angle inward to meet the back section side edges 1204, 1206. Accordingly, the front section 1200 provides the widest area for standing and maneuvering during use.

The base platform 1006 further includes interior hooks 1214, 1216 positioned inside of the base platform, as opposed to extending from an edge, the interior hooks 1214, 1216 providing locations to secure accessories, such as climbing sticks.

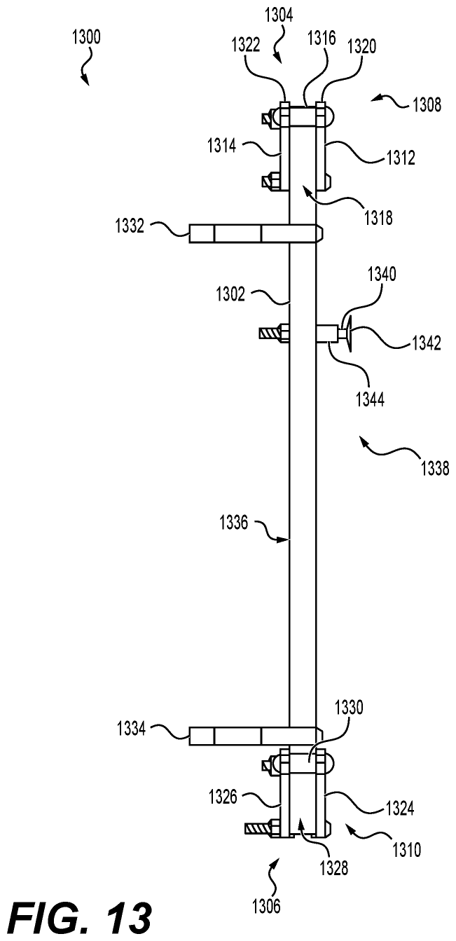

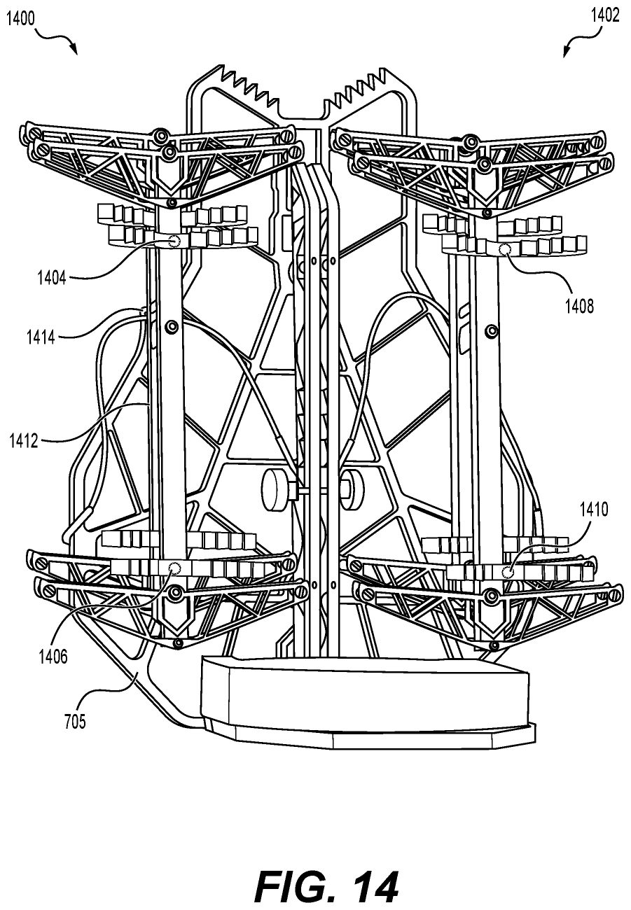

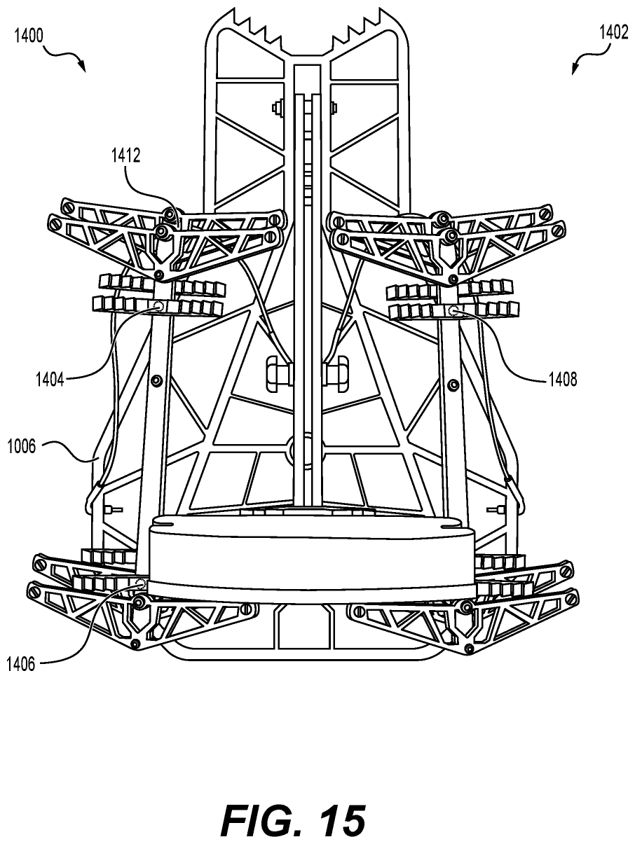

In FIGS. 13, 14, and 15, the two embodiments of the hang on portable tree stands 70, 1000 are shown with attached sets of climbing sticks. As discussed above, the base platform 705 includes exterior hooks 740, 742 and the base platform 1006 includes interior hooks 1214, 1216 for receiving accessories such that the accessories are conveniently transported with the portable hang on tree stands 70, 1000. One such accessory is one or more climbing sticks 1300 as shown in FIG. 13. Those skilled in the art will appreciate that the one or more climbing sticks 1300 can be arranged in sets of climbing sticks, as shown in FIGS. 14 and 15, such that the user can transport a plurality of climbing sticks easily. Climbing sticks are generally known in the art and provide apparatuses for climbing a tree. For example, a user may desire to position the hang on portable tree stand at an elevation in a tree that they are not able to easily climb without assistance, and therefore, the user can utilize one or more climbing sticks to secure to the tree and gain elevation.

As shown in FIG. 13, in the present invention, one embodiment of a climbing stick 1300 includes a support bar 1302 extending from a top end 1304 to a bottom end 1306. The support bar 1302 may vary in length, thereby providing an appropriate fit for users of varying heights. Climbing stick 1300 further includes a top foot rung 1308 secured near the top end 1304 and a bottom foot rung 1310 secured near the bottom end 1306. The top and bottom foot rungs 1308, 1310 may be secured to the support bar 1302 via any means known in the art.

The top foot rung 1308 includes a front side 1312 and a back side 1314 secured together via the one or more bolts and spacers 1316 such that a gap 1318 is created between the front side 1312 and the back side 1314 as the support bar 1302 is secured between the front side 1312 and back side 1314. The use of a front side 1312 and a back side 1314 with a gap therebetween, ensures that the user has two contact surfaces, i.e. top edges 1320, 1322 for engagement with their foot in use, while also reducing mass of the foot rung 1308 and therefore an overall weight of the climbing stick 1300. The front side 1312 and the back side 1314, in embodiments, are of the same shape and overall structure, each including a plurality of openings to aid in reducing an overall weight of the climbing stick 1300.

Bottom foot rung 1310 is configured substantially the same as top foot rung 1308. Specifically, bottom foot rung 1310 includes a front side 1324 and a back side 1326, spaced apart via a gap 1328 such that the support bar 1302 is secured therebetween, along with one or more bolts and spacers 1330.

Climbing stick 1300 further includes one or more braces 1332, 1334 extending from a rear surface 1336 of the support bar 1302, the braces configured to engage with a tree when in use. Further, a strap receiver 1338 extends from the support bar 1302 in a direction opposite the braces 1332, 1334. The strap receiver 1338 may vary in form, as would be understood by those skilled in the art. In embodiments, the strap receiver 1338 includes a bolt 1340 with a circular head 1342 configured to receive a strap or other flexible member, such as via a hoop. A spacer 1344, in embodiments, is used to extend the circular head 1342 a distance away from the support bar 1302. As shown best in FIGS. 14 and 15, the strap receiver 1338 also provides for a mechanism to engage with the base platform 705 via the exterior hooks 740, 742 and the base platform 1006 via the interior hooks 1214, 1216. In other words, the circular head 1342 will lock into these hooks such that one or more sets of climbing sticks are transported along with the portable hang on tree stand.

This combination of a hang on portable tree stand with one or more climbing sticks, allows for a user to easily carry all of the necessary equipment for climbing and stationing in a tree at a desired elevation. The combination remains lightweight due to the selected materials, as well as the design of the base platform, seat, upright posts, and foot rungs all having a plurality of openings extending therethrough.

As shown in FIG. 14, two sets of climbing sticks 1400, 1402 are engaged with the base platform 705 via hooks 740, 742 (not visible in FIG. 14). The sets of climbing sticks 1400, 1402 are sets of two, however, additional climbing sticks may be added to each set via magnetic retention (e.g. magnets 1404, 1406, 1408, 1410). In other words, the user can create sets that include the desired number of climbing sticks, and then utilize the bottom climbing stick (i.e. climbing stick 1412) to secure to the base platform 705 via the associated strap receiver 1414 and hook 740.

Similarly, as shown in FIG. 15, two sets of climbing sticks 1400, 1402 are engaged with the base platform 1006 via the interior hooks 1214, 1216 (not visible in FIG. 15). The sets of climbing sticks 1400, 1402 are again shown in sets of two, however additional climbing sticks may be added via magnets 1404, 1406, 1408. The bottom climbing stick(s) 1412 will secure to the base platform 1006 via the strap receiver and interior hooks. Accordingly, the present invention provides for a combination of a hang on portable tree stand and climbing sticks.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A hang on portable tree stand, comprising:
a first upright post and a second upright post each extending from a top end to a bottom end, each of the first and second upright posts having a plurality of openings extending through a thickness of each of the first and second upright posts;
a seat engaged with the first and second upright posts, the seat having a plurality of irregularly shaped openings extending through a thickness of the seat;
a base platform pivotally engaged with the first and second upright posts, the base platform having a plurality of irregularly shaped openings extending through a thickness of the base platform;
one or more supports extending from the base platform to the first and second upright posts, the one or more supports being configured to allow the base platform to pivot toward the first and second upright posts;
one or more braces extending from the first and second upright posts; and
a strap receiver extending from the first and second upright posts;
wherein the base platform and the one or more braces are configured to engage with a support structure when the hang on portable tree stand is installed on the support structure; and
wherein the strap receiver is configured to receive a strap, the strap being configured to secure around the support structure and hold the hang on portable tree stand in place once installed.

2. The hang on portable tree stand of claim 1, wherein the base platform further comprises a plurality of teeth extending from a back end of the base platform, the plurality of teeth configured to engage with the support structure, the plurality of teeth pivot with the base platform.

3. The hang on portable tree stand of claim 1, wherein the base platform is pivotally engaged with the first and second upright posts via a pin extending through a transverse bore, the transverse bore extending through the first and second upright posts and one or more bars as part of the base platform.

4. The hang on portable tree stand of claim 1, further comprising a shelf extending from at least one of the first and second upright posts at a position below the seat, the shelf supports the seat in a substantially horizontal configuration.

5. The hang on portable tree stand of claim 4, further comprising an adjustable button attached to and extending from a bottom surface of the seat, the adjustable button is configured to extend and contract such that an angle of the seat is adjustable relative to the first and second upright posts, the adjustable button configured to rest on the shelf to support the seat in the substantially horizontal configuration.

6. The hang on portable tree stand of claim 1, further comprising:
a plurality of grooves extending through each of the first and second upright posts, the plurality of grooves being vertically aligned; and
a bar attached to the one or more supports such that the bar couples the one or more supports to the first and second upright posts;
wherein the bar is adjustable in a vertical position by being selectively positioned in one of the plurality of grooves.

7. The hang on portable tree stand of claim 1, wherein the strap receiver further comprises:
a center bridge connecting the strap receiver to the first and second upright posts;
a first receiving element extending from the center bridge and creating a first semi-circular indention and a first rectangular indention; and
a second receiving element extending from the center bridge in a direction opposite of the first receiving element, the second receiving element creating a second semi-circular indention and a second rectangular indention;
wherein the first semi-circular indention, first rectangular indention, second semi-circular indention, and second rectangular indention provide locations for securing the strap.

8. The hang on portable tree stand of claim 1, wherein the strap receiver comprises a knob extending forward from the first and second upright posts.

9. The hang on portable tree stand of claim 1, wherein the base platform further comprises one or more hooks integral with and extending outwardly from a side edge of the base platform.

10. The hang on portable tree stand of claim 1, wherein the base platform further comprises one or more hooks integral with and extending inwardly from a side edge of the base platform.

11. The hang on portable tree stand of claim 1, wherein the hang on portable tree stand has a weight of approximately 10.4 pounds.

12. The hang on portable tree stand of claim 1, wherein the hang on portable tree stand has a weight of approximately 6.25 pounds.

13. The hang on portable tree stand of claim 1, wherein the hang on portable tree stand has a weight of approximately 8 pounds.

14. The hang on portable tree stand of claim 1, wherein the base platform further comprises:
a front section defined by a front end edge, a first side edge, and a second side edge, the first side edge and the second side edge connecting to the front end edge at substantially right angles and extending away therefrom such that the first side edge and the second side edge are perpendicular to one another;
a back section integral with the front section, the back section defined by:
a back end forming a lower brace of the one or more braces, the lower brace having a first jaw and a second jaw coming together at a bridge, the first jaw and the second jaw forming concave opening configured to receive the support structure therein;
a back section first side edge connecting the first jaw to the first side edge of the front section; and
a back section second side edge connecting the second jaw to the second side edge of the front section;
wherein the back section first side edge and the back section second side edge are angled inward from the first side edge and the second side edge.

15. The hang on portable tree stand of claim 1, wherein the base platform further comprises:
a front section defined by:
a front end edge;
a first side edge having a first section, a second section, and a third section, the first section connected to the front end edge at an angle greater than 90 degrees, the second section connected to the first section at an angle greater than 90 degrees, the third section connected to the second section at an angle greater than 90 degrees, wherein the second section is perpendicular to the front end edge; and
a second side edge connected to and extending from the front end edge, the second side edge being a mirror configuration of the first side edge;
a back section integral with the front section, the back defined by a back end forming a lower brace of the one or more braces, a first back section side edge integral with and extending from the lower brace to the first side edge, and a second back section side edge integral with and extending from the lower brace to the second side edge;
wherein the first back section side edge and the second back section side edge extend parallel to one another.

16. The hang on portable tree stand of claim 1, wherein the one or more braces each further comprises a first jaw and a second jaw, the first jaw and the second jaw connected at an intermediate connecting portion such that the first jaw and the second jaw extending outward therefrom and create a concave opening for receiving the support structure therein.

17. The hang on portable tree stand of claim 1, wherein at least one of the one or more braces further comprises a plurality of teeth extending from a first end to a second end of the at least one of the one or more braces.

18. A combination of a hang on portable tree stand and a set of climbing sticks, the combination comprising:
the hang on portable tree stand having:
a pair of upright posts extending from a top end to a bottom end;
a seat engaged with the pair of upright posts near the top end;
a base platform pivotally engaged with the pair of upright posts near the bottom end, the base platform having one or more hooks extending from an edge of the base platform;
one or more supports extending from the base platform to the pair of upright posts, the one or more supports being configured to allow the base platform to pivot toward the pair of upright posts;
one or more braces extending from the pair of upright posts and configured to engage with a support structure; and
a strap receiver extending from the pair of upright posts and configured to receive a strap to secure the hang on portable tree stand to the support structure; and
the set of climbing sticks including a first climbing stick having a support bar extending from a top end to a bottom end, a top foot rung secured to the support bar near the top end, a bottom foot rung secured to the support bar near the bottom end, and a climbing stick strap receiver extending from the support bar;
wherein the first climbing stick is configured to attach to the base platform via the climbing stick strap receiver engaging with one of the one or more hooks such that the one of the one or more hooks retains the first climbing stick to the base platform.

19. The combination of claim 18, wherein the set of climbing sticks further comprises the first climbing stick and a second climbing stick, the first climbing stick and the second climbing stick configured to secure together via magnetic retention such that attaching the first climbing stick to the base platform via the climbing stick strap receiver and the one of the one or more hooks secures the set of climbing sticks to the portable hang on tree stand.

20. The combination of claim 18, wherein the climbing stick strap receiver further comprises a circular head extending out from the support bar via a bolt, the circular head configured to hold the climbing stick strap receiver to the one of the one or more hooks.
